(19) United States
(12) Patent Application Publication
(10) Pub. No.: US 2018/0300467 A1
(43) Pub. Date: Oct. 18, 2018

(54) PAIRING A USER WITH A WEARABLE COMPUTING DEVICE

(71) Applicant: INTEL CORPORATION, Santa Clara, CA (US)

(72) Inventors: Wah Yiu Kwong, Hillsboro, OR (US); Hong W. Wong, Portland, OR (US); Jiancheng Tao, Shanghai (CN); Xiaoguo Liang, Shanghai (CN); Cheong Wai Wong, Beaverton, OR (US)

(73) Assignee: INTEL CORPORATION, Santa Clara, CA (US)

(21) Appl. No.: 15/577,835

(22) PCT Filed: Jun. 29, 2015
(86) PCT No.: PCT/US2015/082632

§ 371 Date: Nov. 29, 2017

(51) Int. Cl. G06F 21/32

(52) U.S. Cl. CPC G06F 21/32; G06K 9/00087

(57) ABSTRACT

A wearable apparatus that pairs with a user is described herein. The apparatus includes a processor and a memory. The memory includes code that causes the processor to capture a representation of a identifying feature on a user. The representation is associated with the wearable apparatus. A representation of a wearer of the wearable apparatus is captured. The wearer is authorized to use the wearable apparatus if the representation of the identifying feature matches the representation of the wearer. The wearer is prevented from using the wearable apparatus if there is no match.

### TECHNICAL FIELD

This disclosure relates generally to wearable computing devices. Specifically, this disclosure relates to pairing a wearable computing device with its user.

### BACKGROUND

Computing devices have advanced to the point where they can now be a fashion statement. Wearable computing devices, such as glasses, watches, and so on, provide many conveniences, but come with an inherent security risk. If someone steals the wearable device, it is possible the thief can gain access to the owner's secure information, and the owner's other smart devices, potentially, to gain access to the owner's car or the home,

### BRIEF DESCRIPTION OF THE DRAWINGS

FIG. 1A is a diagram of an example smart ring being worn on a user's finger;

FIG. 1B is a diagram of an example smart ring and a smart phone;

FIG. 1C is a diagram of an example smart bracelet worn on a user's wrist;

FIG. 1D is a diagram of an example smart watch worn on the user's wrist;

FIG. 2A is a diagram of example tattoos that may be used to pair a user with a wearable computing device;

FIG. 2B is a diagram of example tattoos that may be used to pair the user with the wearable computing device;

FIG. 3 is a diagram of an example smart ring for detecting images on the user's finger;

FIG. 4 is a diagram of system for pairing a wearable computing device with a user;

FIG. 5 is a block diagram of the components of the smart ring;

FIG. 6 is a process flow diagram of a method for pairing the user with the wearable computing device; and

FIG. 7 is a block diagram of an example wearable computing device.

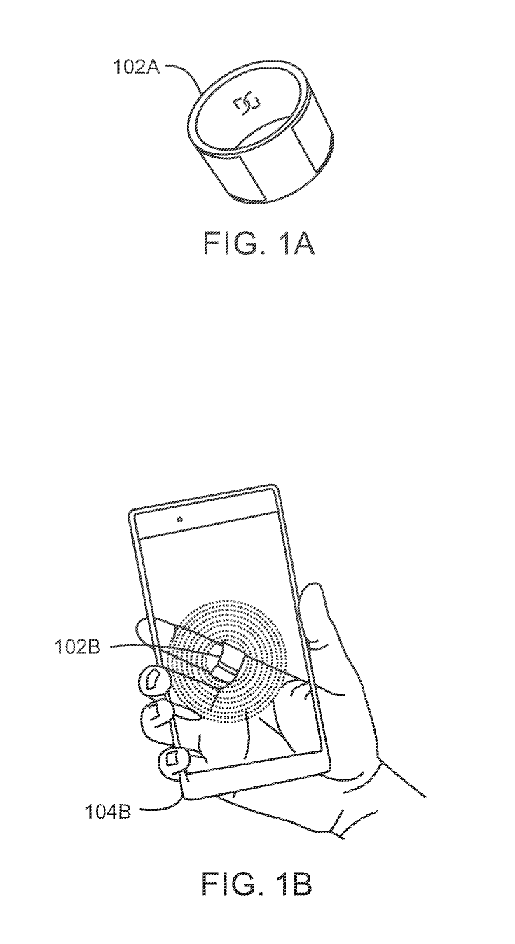

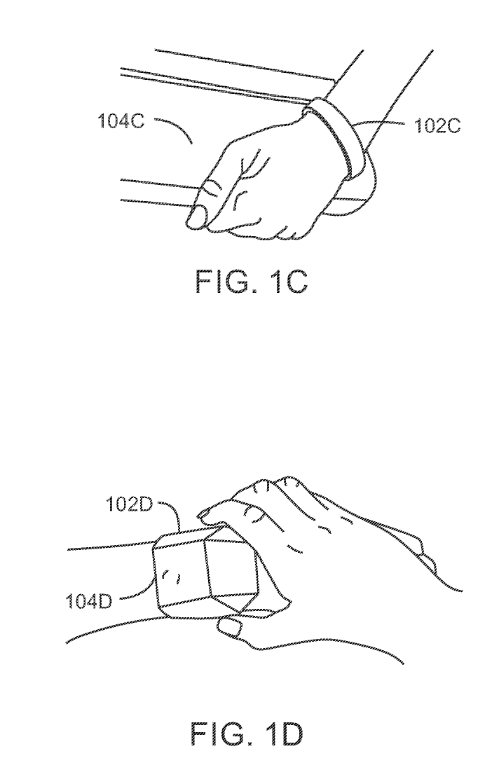

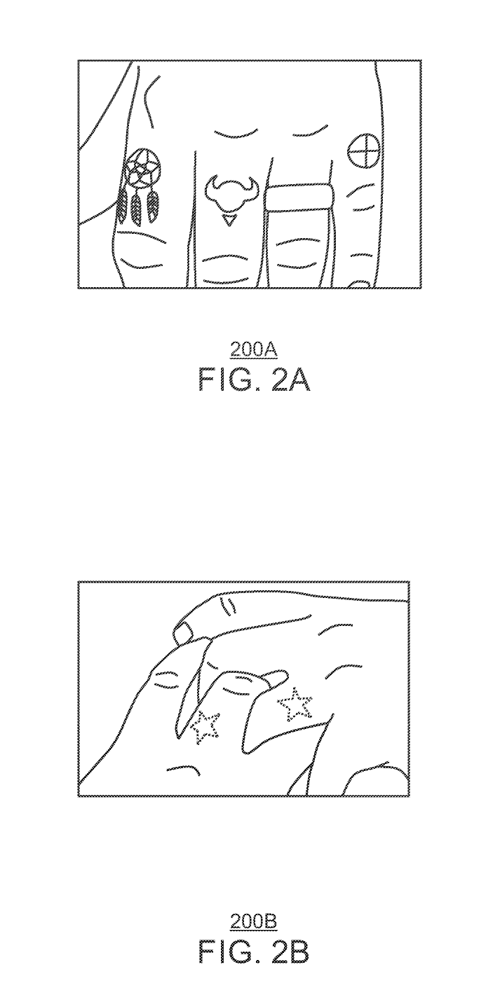

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description, numerous specific details are set forth, such as examples of specific types of processors and system configurations, specific hardware structures, specific architectural and micro architectural details, specific register configurations, specific instruction types, specific system components, specific measurements or heights, specific processor pipeline stages and operation, etc., in order to provide a thorough understanding of the present invention. It will be apparent, however, to one skilled in the art that these specific details need not be employed to practice the present invention. In other instances, well known components or methods, such as specific and alternative processor architectures, specific logic circuits or code for described algorithms, specific firmware code, specific interconnect operation, specific logic configurations, specific manufacturing techniques and materials, specific compiler implementations, specific expression of algorithms in code, specific power down and gating techniques or logic and other specific operational details of computer system have not been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to smart rings, and may be also used in other devices, such as wearable and handheld devices, systems on a chip (SOC) devices, and embedded applications. Some examples of handheld devices include cellular phones, Internet protocol devices, digital cameras, and handheld PCs. Embedded applications typically include a microcontroller, a digital signal processor (DSP), a system on a chip, network computers (NetPC), or any other system that can perform the functions and operations taught below. Moreover, the apparatuses, methods, and systems described herein are not limited to physical computing devices, but may also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future balanced with performance considerations.

Embodiments of the present techniques provide a mobile device that is paired with a user based on an identifying feature on the user's skin. In one embodiment, the identifying feature is a tattoo. However, other identifying features may be used, such as freckles, scars, birthmarks, and moles. Once the device is paired with a user, only the user with the same identifying feature is authorized to use the device.

FIG. 1A is a diagram of an example smart ring 102A being worn by a user. The smart ring 102A is a wearable computing device that allows a user to combine fashion and technology. For example, the smart ring 102A may be used to store personal information such as, phone number, mailing address, email, and so on. The smart ring 102A may also be used to provide a password to unlock doors, or access secure computing devices, such as a smart phone. The smart ring 102A may also be used to unlock mobile apps. In one embodiment, the smart ring 102A is a near field communication (NFC) enabled device that allows users to upload information to the smart ring 102A using a mobile app. Additionally, the smart ring 102A can be used to share information with other NFC devices, such as contact details, website links, pictures, Wi-Fi access information, or whatever is suitable to be passed securely to friends, through their smartphones, tablets, and other NFC enabled devices. In one embodiment, touching the smart ring 102A to another user's smartphone shares contact data as a digital name card.

Further, the smart ring 102A includes a detection device (not shown), such as a camera to detect and verify the owner's identifying feature, The user pairs with the smart ring 102A by placing the smart ring 102A on a ring with an identifying feature. The camera takes a picture of the identifying feature, and stores the image locally. After the pairing, no one can use the device unless the user can place the ring on a finger with the identifying feature. The smart ring 102A may also enable the user to change the identifying feature, for example, if the smart ring 102A is sold. Additionally, the ring may have integrated wireless charging coils that can be charged via induction. Alternatively, the smart ring 102A may be charged via resonance wireless charging schemes with external excitation charge coils. In one embodiment, a thermal-electro power convertor harvests thermal power from the finger to charge the smart ring 102A.

FIG. 1B is a diagram of an example smart ring 102B and a smart phone 104B. In one embodiment of the present techniques, the smart ring 102B may be used to provide a password to unlock the smart phone 104B. In another embodiment of the present techniques, the user may be paired with the smart ring 102B and the smart phone 104B,

FIG. 1C is a diagram of an example smart bracelet 102C worn on a user's wrist. The smart bracelet 1020 is a wearable computing device that may have similar functionality to the smart rings 102A, 102B. In one embodiment the smart bracelet 1020 provides a password to login to a secure computing device in the user's purse 104C.

FIG. 1D is a diagram of an example smart watch 102D worn on the user's wrist. The smart watch 102D includes a display 104D.

As stated previously, the wearable computing device may be any device, such as a ring, bracelet, watch, glasses, and so on. However, for the sake of clarity, embodiments of the present techniques are discussed with respect to the smart ring 102A. It is understood that any wearable computing device may be used to implement the present techniques.

FIG. 2A is a diagram of tattoos 200A that may be used to pair the user with the wearable computing device. As stated previously, a wearable computing device may read a tattoo on the user's skin to pair the user with the device. Thereafter, the device only allows associated users access to the electronic data and programs on the wearable device. The tattoo may be an image or a binary code on the user's skin; additionally, the tattoo may be permanent or semi-permanent, conductive or non-conductive, and visible or invisible under natural light.

The tattoos 200A are examples of permanent ink tattoos. In an embodiment of the present techniques, the smart ring 102A is placed on top of one of these tattoos 200A by the user putting on the smart ring 102A. A visible light camera on the smart ring 102A takes a picture of the tattoo 200A, or a portion thereof. The smart ring 102A is then paired to the user based on the tattoo 200A. Further use of the ring is secured by authenticating the paired. image of the tattoo 200A against the finger of any wearer of the smart ring 102A.

FIG. 2B is a diagram of tattoos 200B that may be used to pair a user with a wearable computing device. The ink of the tattoo 20013 is only visible under ultraviolet (UV) light, i.e., invisible under natural light. Accordingly, the smart ring 102A may include a camera and a UV light. The camera takes a picture of the UV ink tattoo 200B to pair the smart ring 102A to the user. In one embodiment, an indicator on the wearable device indicates the wearable device has been paired with the user. For example, a light on the smart ring 102A may illuminate once the user with the tattoo 2001 has been verified.

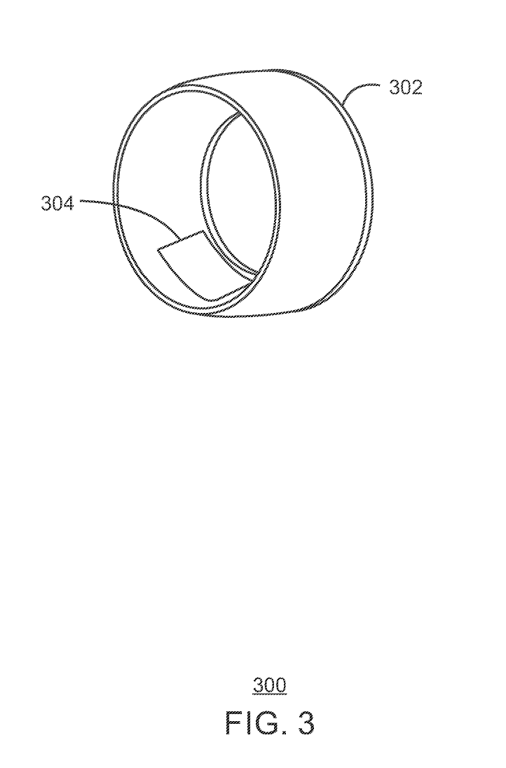

FIG. 3 is a diagram of a smart ring 302 for detecting an identifying feature on the user's finger. The smart ring 302 includes, on the inner surface of the ring, an image, or infrared thermal, or finger print sensor, used to detect the identifying feature. The infrared thermal sensor may be used to detect identifying features with a thermal image of the portion of the user's that the sensor covers. In another embodiment, the user may pair with the smart ring 102A by holding the sensor over the fingerprint of the user. In this way, the smart ring 102A is paired with the user as the user is putting on the smart ring 102A.

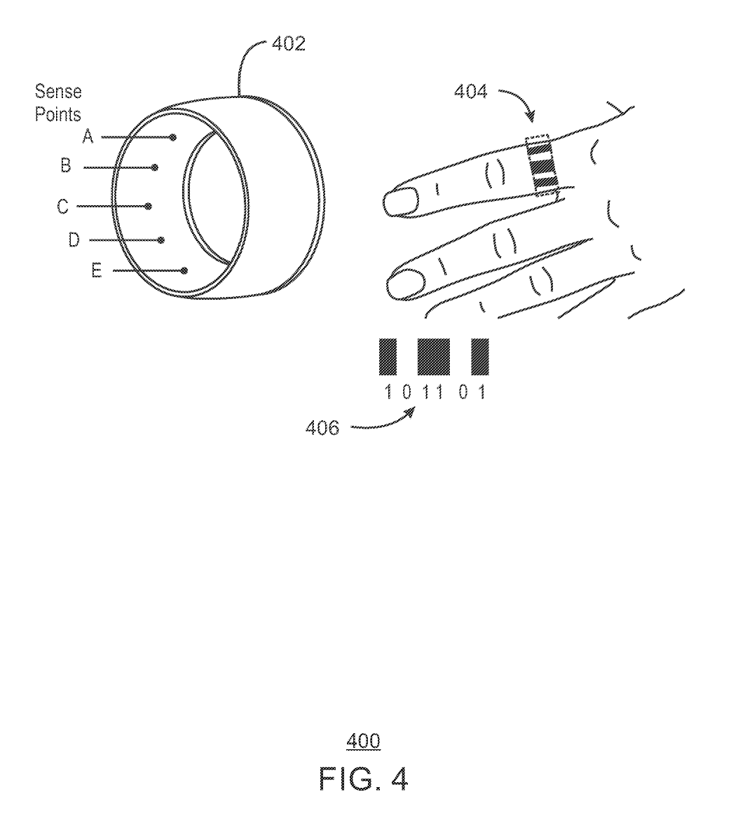

FIG. 4 is a diagram of system 400 for pairing a wearable computing device with a user. The system 400 includes a smart ring 402 and a patterned tattoo 404. in an embodiment of the present techniques, the tattoo 404 is written in conductive ink that represents a binary code 406. For example, each stripe of conductive ink shown in the tattoo 404 represents a 1, and each blank stripe represents a 0. As shown, the binary code 406 represented by the tattoo is “101101.” The inner surface of the smart ring 402 includes sense points (A-E) for detecting the conductive ink (or absence thereof), and hence, the binary code 406. The smart bracelet 1000 may operate similarly.

Advantageously, the tattooed code can be modified by replacing one or more of the 0's to 1's. For example, the binary code 406 may be changed from 101101 to 101111, by filling the last 0 spot with conductive ink.

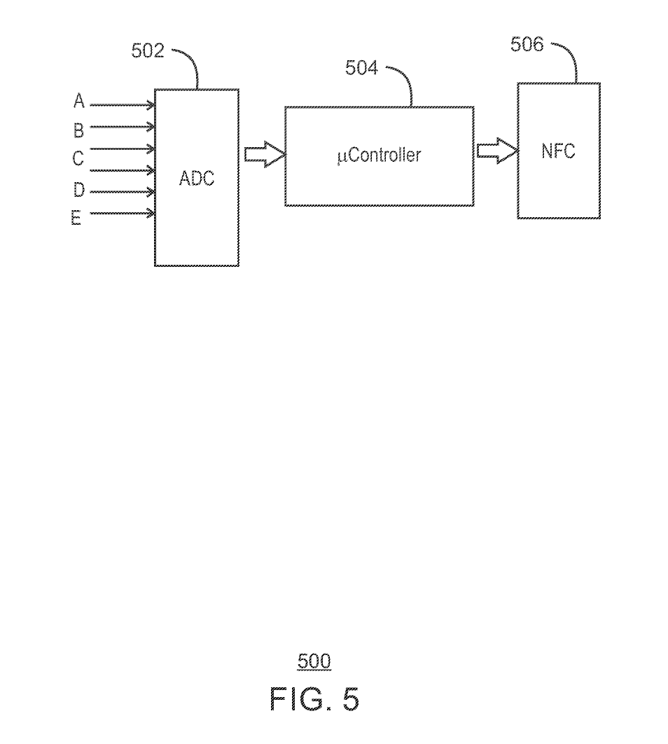

FIG. 5 is a block diagram 500 of the components of the smart ring 402. The components include the conductive sense points A-E, analog to digital controller (ADC) 502, controller 504, and near field communicator (NFC) 506. The ADC 502 obtains the binary code 406 from the finger by using capacitive or resistive sensing. The sense points A-E on the inner surface of the ring can measure the resistivity of the skin where there is embedded binary code. Where he sense points A-E touch the conductive ink, the resistivity is lower and is interpreted as a zero. Where the sense points A-E do not touch the conductive ink, the resistivity is higher and is interpreted as a one. The sense points A-E may work similarly with measurements in capacitance, instead of resistance.

The ADC 502 sends the binary code to the controller 504. The controller 504 compares the binary code with the stored key. If the keys match, the smart ring 402 provides access to data on the smart ring 402, and other functionality, such as the NFC 506. The controller 504 also stores the binary code when the user first pairs with the smart ring 402, The binary code can be stored in flash storage inside the controller 504.

The NFC 506 is a proximity sensor and also an authentication device, which allows the user wearing the smart ring to log onto the smart phone which supports NFC authentication for user login, as illustrated in FIG. 1B. Once the ring is removed, the user is authenticated again before allowing use of the smart ring.

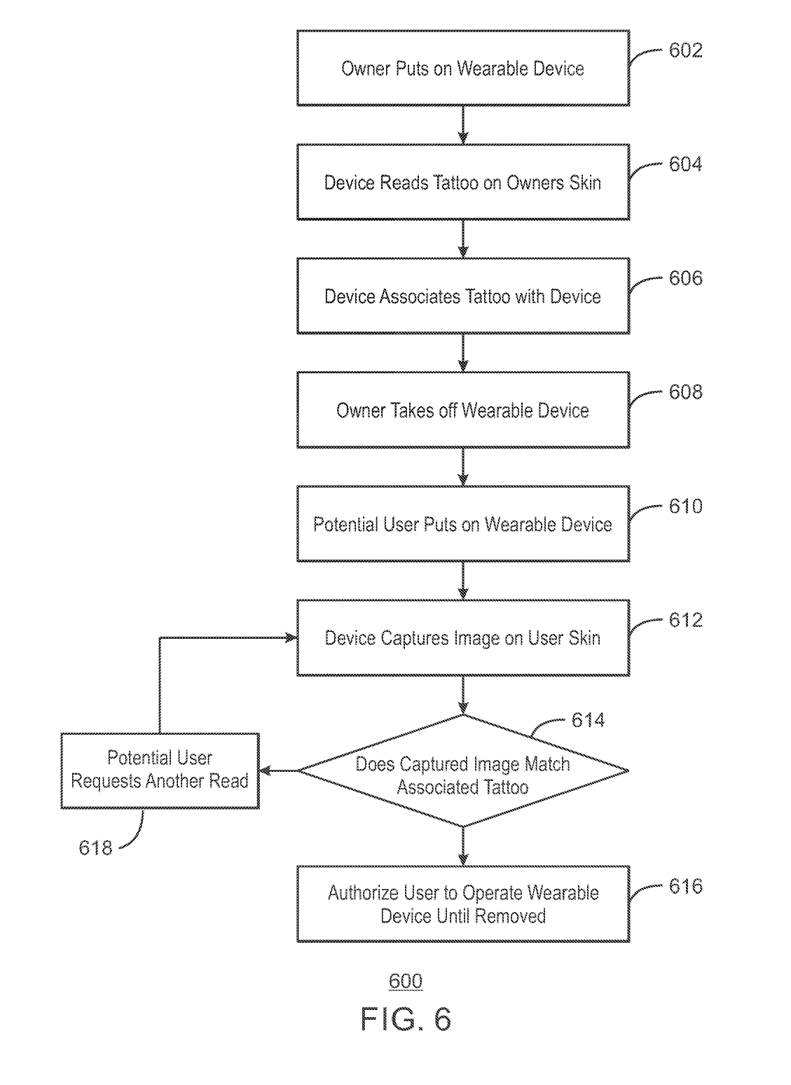

FIG. 6 is a process flow diagram of a method 600 for pairing the user with the wearable computing device. The process flow diagram is not intended to represent a sequence of performing the method 600. The method 600 begins at block 602, where the puts on the wearable computing device. In one embodiment, the user places a new ring on the finger. At block 604, the device reads an identifying tattoo on the owner's skin. At block 606, the identifying tattoo is associated with the wearable device. In one embodiment, an image of the identifying tattoo is stored on the wearable device. At block 608, the owner takes off the wearable device.

At block 610, a potential user puts on the wearable device. At block 612, the wearable device sensor performs its capture on the portion of the user's skin covered by the wearable device. The capture may be taking a picture in the visible, UV, or infrared spectrums. Alternatively, the capture may be a conductive read of a tattoo written in conductive ink, as described with respect to FIGS. 4 and 5.

At block 614, the capture is compared with the identifying feature used to pair with the device. If there is a match, at block 616, the user is authorized to use the wearable device. If there is not a match, at block 618, the user may request another read, and block 612 repeats. Alternatively, the wearable device may turn off. If the identifying feature changes from environmental affects, or accident, the user may re-pair with the wearable device using a tool such as, a mobile application. In one embodiment, the mobile application resides on a smart phone, tablet, or notebook computer, and interfaces with the wearable device via a wireless technology, such as Bluetooth.

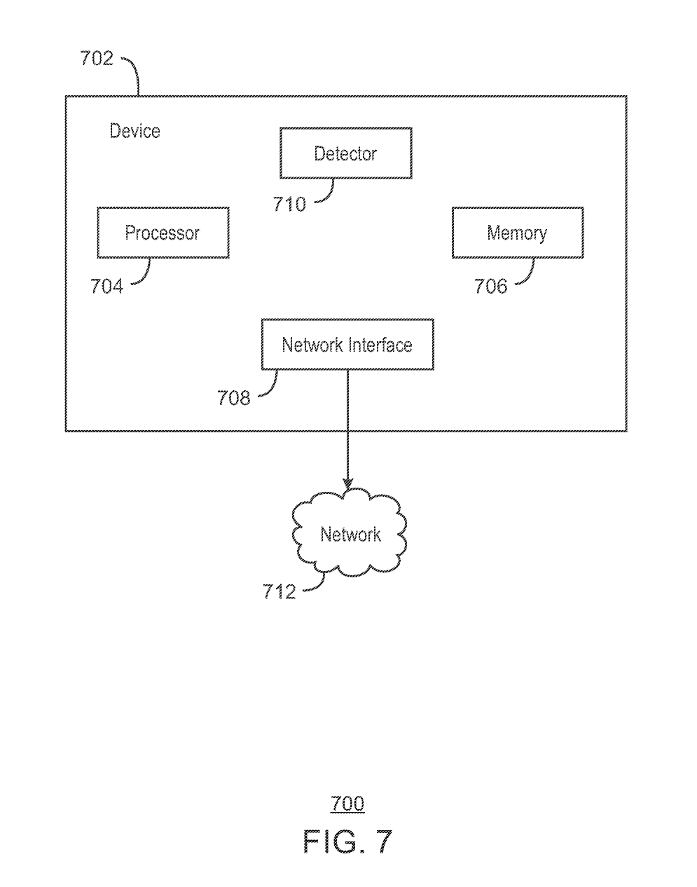

FIG. 7 is a block diagram illustrating an example wearable computing device. The computing device 700 may include a central processing unit (CPU) 704 that executes stored instructions, as well as a memory device 706 that stores instructions that are executable by the CPU 704, The CPU 704 may be coupled to the memory device 706 by a bus (not shown). Further, the computing device 700 may include more than one CPU 704. The memory device 706 can include random access memory (RAM), read only memory (ROM), flash memory, or any other suitable memory systems. For example, the memory device 706 may include dynamic random access memory (DRAM).

The computing device 700 also includes a network interface 708. The network interface 708 connects the computing device 700 to a network 712. The network 712 may be a wide area network (WAN), local area network (LAN), or the Internet, among others. In some examples, the device may communicate with other devices through a wireless technology, The computing device 700 also includes a detector 710. The detector 710 is used to detect the identifying feature, or the lack thereof, on the wearer. The detector 710 may be a red-green-blue (RGB) camera, an infrared camera, an RGB camera with a UV light, a set of conductive sense points, and the like.

The block diagram of FIG. 7 is not intended to indicate that the computing device 700 is to include all of the components shown in FIG. 7. Rather, the computing system 700 can include fewer or additional components not illustrated in FIG. 7, such as sensors, additional network interfaces, and the like. The computing device 700 may include any number of additional components not shown in FIG. 7, depending on the details of the specific implementation. Furthermore, any of the functionalities of the CPU 704 may be partially, or entirely, implemented in hardware or in a processor. For example, the techniques described herein may be implemented with logic, such as an application specific integrated circuit, in logic implemented in a processor, or other dedicated hardware circuitry.

### EXAMPLES

An example apparatus includes logic. The logic at least partially includes hardware logic to capture a representation of a tattoo on a user. The representation of the tattoo is associated with the apparatus. A representation of a wearer of the apparatus is captured. The wearer is authorized to use the apparatus if the representation of the wearer matches the representation of the tattoo. The wearer is prevented from using the apparatus if the representation of the wearer does not match the representation of the tattoo.

An example apparatus includes a camera. The representation of the tattoo is an image of he tattoo. The representation of the wearer is an image of the wearer.

In an example apparatus, the image of the tattoo represents a binary code. The representation of the wearer matches the representation of the tattoo if the image of the wearer represents a same binary code as the binary code.

An example apparatus includes conductive sensors. The tattoo on the user includes conductive ink. Capturing the representation of the tattoo includes sensing a first pattern of the conductive ink. In an example apparatus, capturing the representation of the wearer includes sensing a second pattern of the conductive ink.

In an example apparatus, the tattoo includes ink that is only visible under ultraviolet light. An example apparatus includes an ultraviolet light source that illuminates the tattoo for capture of the representation of the tattoo. The example apparatus illuminates the wearer for capture of the representation of the wearer.

An example method for pairing a wearable apparatus with a user is described herein. The method includes capturing a representation of a tattoo on a user. The method also includes associating the representation with the apparatus. The method further includes capturing a representation of a wearer of the apparatus. The method also includes authorizing the wearer to use the apparatus if the representation of the wearer matches the representation of the tattoo. Additionally, the method includes preventing the wearer from using the apparatus if the representation of the wearer does not match the representation of the tattoo.

In an example method, the representation of the tattoo is an image of the tattoo, and the representation of the wearer is an image of the wearer. In an example method, the image of the tattoo represents a binary code, and the representation of the wearer matches the representation of the tattoo if the image of the wearer represents a same binary code as the binary code.

In an example method, the tattoo on the user includes conductive ink, and wherein capturing the representation of the tattoo includes sensing a first pattern of the conductive ink. In an example method, capturing the representation of the wearer it eludes sensing a second pattern of the conductive ink.

In an example method, the tattoo includes ink that is only visible under ultraviolet light. An example method includes illuminating the tattoo with an ultraviolet light source for capture of the representation of the tattoo. An example method includes illuminating the wearer with an ultraviolet light source for capture of the representation of the wearer.

An example computer readable medium for pairing a wearable device with a user is described herein. The medium has instructions stored therein that, in response to being executed on the wearable device, cause the wearable device to capture a representation of a tattoo on a user. The representation of the tattoo is associated with the apparatus. A representation of a wearer of the apparatus is captured. The wearer is authorized to use the apparatus if the representation of the wearer matches the representation of the tattoo. The wearer is prevented from using the apparatus if the representation of the wearer does not match the representation of the tattoo.

In an example computer readable medium, the representation of the tattoo is an image of the tattoo, and the representation of the wearer is an image of the wearer. In an example computer readable medium, the image of the tattoo represents a binary code, and the representation of the wearer matches the representation of the tattoo if the image of the wearer represents a same binary code as the binary code.

In an example computer readable medium, the tattoo on the user includes conductive ink, and capturing the representation of the tattoo includes sensing a first pattern of the conductive ink. In an example computer readable medium, capturing the representation of the wearer includes sensing a second pattern of the conductive ink.

In an example computer readable medium, the tattoo includes ink that is only visible under ultraviolet light. An example computer readable medium includes instructions that cause the wearable device to illuminate the tattoo with an ultraviolet light source for capture of the representation of the tattoo, and illuminate the wearer with an ultraviolet light source for capture of the representation of the wearer.

In an example computer medium, the image of the tattoo represents a binary code, and the representation of the wearer matches the representation of the tattoo if the image of the wearer represents a same binary code as the binary code.

In an example computer readable medium, the tattoo on the user includes conductive ink, and capturing the representation of the tattoo includes sensing a first pattern of the conductive ink. In an example computer readable medium, capturing the representation of the wearer includes sensing a second pattern of the conductive ink.

In an example computer readable medium, the tattoo includes ink that is only visible under ultraviolet light. In an example computer readable medium, the instructions cause the wearable device to illuminate the tattoo with an ultraviolet light source for capture of the representation of the tattoo.

In an example system for pairing a wearable device with a user, the system includes a processor and a memory. The memory includes instructions that cause the processor to capture a representation of an identifying feature on a user. The representation of the identifying feature is associated with the apparatus. A representation of a wearer of the apparatus is captured. The wearer is authorized to use the apparatus if the representation of the wearer matches the representation of the identifying feature. The wearer is prevented from using the apparatus if the representation of the wearer does not match the representation of the identifying feature.

In an example system, the representation of the identifying feature includes an image of the user's skin. In an example system, the identifying feature includes at least a. portion of a fingerprint.

In an example system, the identifying feature includes a tattoo, and the representation of the wearer includes an image of the tattoo. In an example system, the image of the identifying feature represents a binary code, and the representation of the wearer matches the representation of the identifying feature if the image of the wearer represents a same binary code as the binary code. In an example system, the image of the tattoo represents a binary code, and the representation of the wearer matches the representation of the tattoo if the image of the wearer represents a same binary code as the binary code.

In an example system, the tattoo on the user includes conductive ink, and capturing the representation of the tattoo includes sensing a first pattern of the conductive ink. In an example system, capturing the representation of the wearer includes sensing a second pattern of the conductive ink.

In an example system claim 34, the tattoo includes ink that is only visible under ultraviolet light. In an example system, the instructions cause the wearable device to illuminate the tattoo with an ultraviolet light source for capture of the representation of the tattoo.

In an example method for pairing a wearable device with a user, the method includes capturing a representation of an identifying feature on a user. The method also includes associating the representation of the identifying feature with the apparatus. Additionally, the method includes preventing a wearer from using the apparatus if a representation of the wearer does not match the representation of the identifying feature.

In an example method, a representation of a wearer of the apparatus is captured. Additionally, the wearer is authorized to use the apparatus if the representation of the wearer matches the representation of the identifying feature.

In an example method, the representation of the identifying feature includes an image of the user's skin. In an example method, the identifying feature includes at least a portion of a fingerprint.

In an example method, the identifying feature includes a tattoo, and the representation of the wearer includes an image of the tattoo. In an example method, the image of the identifying feature represents a binary code, and the representation of the wearer matches the representation of the identifying feature if the image of the wearer represents a same binary code as the binary code. In an example method, the image of the tattoo represents a binary code, and the representation of the wearer matches the representation of the tattoo if the image of the wearer represents a same binary code as the binary code.

In an example method, the tattoo on the user includes conductive ink, and capturing the representation of the tattoo includes sensing a first pattern of the conductive ink. In an example method, capturing the representation of the wearer includes sensing a second pattern of the conductive ink.

In an example method, the tattoo is illuminated with an ultraviolet light source for capture of the representation of the tattoo. The tattoo includes ink that is only visible under ultraviolet light.

Not all components, features, structures, characteristics, etc., described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification claims refer to “an additional” element, that does not preclude there being more than one additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may he used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-25. (canceled)

26. A wearable apparatus that pairs with a wearer, the wearable apparatus comprising:
a processor;
a memory comprising code that causes the processor to:
capture a representation of an identifying feature on a wearer;
associate the representation of the identifying feature with the wearable apparatus;
capture a representation of a wearer of the wearable apparatus;
authorize the wearer to use the wearable apparatus if the representation of the wearer matches the representation of the identifying feature; and
prevent the wearer from using the wearable apparatus if the representation of the wearer does not match the representation of the identifying feature.

27. The wearable apparatus of claim 26, wherein the representation of the identifying feature comprises at least a portion of a fingerprint.

28. The wearable apparatus of claim 29, wherein the representation of the identifying feature comprises a representation of a tattoo.

29. The wearable apparatus of claim 26, wherein the representation of the wearer comprises an image of skin of the wearer.

30. The wearable apparatus of claim 29, comprising a camera, wherein the image of the skin of the wearer comprises a tattoo on the wearer.

31. The wearable apparatus of claim 30, wherein the representation of the tattoo represents a binary code, and wherein the representation of the wearer matches the representation of the identifying feature if the tattoo on the wearer represents a same binary code as the binary code.

32. The wearable apparatus of claim 31, comprising conductive sensors, wherein the tattoo on the wearer comprises conductive ink, and wherein capturing the representation of the wearer comprises sensing a first pattern of the conductive ink.

33. The wearable apparatus of claim 32, wherein capturing the representation of the wearer comprises sensing a second pattern of the conductive ink.

34. The wearable apparatus of claim 33, wherein the tattoo on the wearer comprises ink that is visible under ultraviolet light, and invisible under sunlight.

35. The wearable apparatus of claim 34, comprising an ultraviolet light source that illuminates the tattoo on the wearer for capture of the representation of the tattoo.

36. A method for pairing a wearable apparatus with a wearer, the method comprising:
capturing a representation of an identifying feature on a wearer;
associating the representation of the identifying feature with the wearable apparatus;
capturing a representation of a wearer of the wearable apparatus;
authorizing the wearer to use the wearable apparatus if the representation of the wearer matches the representation of the identifying feature; and
preventing the wearer from using the wearable apparatus if the representation of the wearer does not match the representation of the identifying feature.

37. The method of claim 36, wherein the identifying feature comprises at least a portion of a fingerprint.

38. The method of claim 37, wherein the representation of the wearer comprises an image of the skin of the wearer.

39. The method of claim 38, wherein the skin of the wearer comprises a tattoo on the wearer.

40. The method of claim 39, wherein the representation of the identifying feature comprises a representation of a tattoo.

41. The method of claim 39, comprising capturing the representation of the wearer by sensing a first pattern of conductive ink, wherein the tattoo on the wearer comprises the conductive ink.

42. The method of claim 41, comprising capturing the representation of the wearer by sensing a second pattern of the conductive ink.

43. The method of claim 40, wherein the representation of the tattoo represents a binary code, and wherein the representation of the wearer matches the representation of the identifying feature if the tattoo on the wearer represents a same binary code as the binary code.

44. At least one computer readable medium for pairing a wearable device with a wearer, the medium having instructions stored therein that, in response to being executed on the wearable device, cause the wearable device to:
capture a representation of an identifying feature on a wearer;
associate the representation of the identifying feature with the wearable apparatus;
capture a representation of a wearer of the wearable apparatus;
authorize the wearer to use the wearable apparatus if the representation of the wearer matches the representation of the identifying feature; and
prevent the wearer from using the wearable apparatus if the representation of the wearer does not match the representation of the identifying feature.

45. The computer readable medium of claim 44, wherein the representation of the wearer comprises an image of a tattoo on skin of the wearer, and wherein the representation of the identifying feature comprises a representation of a tattoo, and wherein the representation of the tattoo represents a binary code, and wherein the representation of the wearer matches the representation of the identifying feature if the tattoo on the wearer represents a same binary code as the binary code.
